(19) United States
(12) Patent Application Publication
(10) Pub. No.: US 2026/0222292 A1
(43) Pub. Date: Jul. 30, 2026

(54) COMMUNICATION SYSTEM, SETTING MONITORING METHOD AND PROGRAM

(71) Applicant: NTT, Inc., Tokyo (JP)

(72) Inventors: Manabu YOSHINO, Musashino-shi, Tokyo (JP); Kazutaka HARA, Musashino-shi, Tokyo (JP); Shin KANEKO, Musashino-shi, Tokyo (JP); Junichi KANI, Musashino-shi, Tokyo (JP)

(21) Appl. No.: 19/142,793

(22) PCT Filed: Dec. 26, 2022
(86) PCT No.: PCT/JP2022/047901

§ 371 Date: Jun. 24, 2025

(51) Int. Cl. H04L 41/084; H04L 41/04

(52) U.S. Cl. CPC H04L 41/084; H04L 41/04

(57) ABSTRACT

A communication system including: a main signal transmission/reception unit that transmits and receives a main signal to and from an opposing device via a communication network in which a control device is disposed; and a setting monitoring unit that monitors a related setting in which change of a setting related to the main signal transmission/reception unit is to be restricted, and performs rewriting with preset information or blocks transmission between the main signal transmission/reception unit and the control device disposed in the communication network in a case where a setting of the related setting is not a preset setting.

### TECHNICAL FIELD

The present invention relates to a communication system, a setting monitoring method, and a program.

### BACKGROUND ART

As one of business telecommunication facilities installed in a user's home, there is a communication device (transceiver accommodating device) in which a transceiver used for digital coherent communication is accommodated. The transceiver accommodating device is, for example, a white box transponder including a white box switch (WBS) and a transponder. It is also said to be an open transponder (see, for example, Non Patent Literature 1). Specific examples of the white box switch include Galileo and Cassini.

The white box switch can construct an optical transmission system in combination with a large-capacity coherent optical transceiver by implementing device software (for example, Goldstone in Non Patent Literature 1) on hardware. Usually, software implementation and device control including a transceiver are performed by a local account from a management interface such as a serial port or an Ethernet (registered trademark) port on which the device is implemented.

### CITATION LIST

### Non Patent Literature

Non Patent Literature 1: Nishizawa et al, “Open whitebox architecture for smart integration of optical networking and data center technology”, Jocn-13-1-A78

### SUMMARY OF INVENTION

### Technical Problem

A transceiver accommodated in a transceiver accommodating device can be changed in setting by a user via the transceiver accommodating device. There is a possibility that operation against intention of the telecommunication carrier is executed by control of the transceiver accommodating device by a user who logs in via a management port of the transceiver accommodating device. The operation against intention of the telecommunication carrier is, for example, change and reading of a predetermined setting (related setting) that should not be changed in terms of service of a transceiver accommodating device installed in a user's home or the like or an accommodated transceiver, and rewriting (replacement and addition) of software that should not be changed in terms of service. However, conventionally, there has been an issue that an influence of operation against intention of a telecommunication carrier cannot be reduced.

In view of the above circumstances, an object of the present invention is to provide a technology capable of reducing an influence of operation against intention of a telecommunication carrier regarding a business telecommunication facility installed in a user's home.

### Solution to Problem

An aspect of the present invention is a communication system including: a “main signal transmission/reception unit that transmits and receives a main signal to and from an opposing device via a communication network in which a control device is disposed”; and a “setting monitoring unit that monitors a related setting in which change of a setting related to the main signal transmission/reception unit is to be restricted, and performs rewriting with preset information or blocks transmission between the main signal transmission/reception unit and the control device disposed in the communication network in a case where a setting of the related setting is not a preset setting”.

An aspect of the present invention is a setting monitoring method including: transmitting and receiving a main signal to and from an opposing device via a communication network in which a control device is disposed; and monitoring a related setting in which change of a setting related to a main signal transmission/reception unit that transmits and receives the main signal is to be restricted, and performing rewriting with preset information or blocking transmission between the main signal transmission/reception unit and the control device disposed in the communication network in a case where a setting of the related setting is not a preset setting.

An aspect of the present invention is a program that causes a computer to execute a setting monitoring step of monitoring a related setting in which change of a setting related to a main signal transmission/reception unit that transmits and receives a main signal to and from an opposing device via a communication network in which a control device is disposed is to be restricted, and performing rewriting with preset information or blocking transmission between the main signal transmission/reception unit and the control device disposed in the communication network in a case where a setting of the related setting is not a preset setting.

### Advantageous Effects of Invention

According to the present invention, an influence of operation against intention of a telecommunication carrier regarding a business telecommunication facility installed in a user's home can be reduced.

### BRIEF DESCRIPTION OF DRAWINGS

FIG. 1 A diagram illustrating a configuration example of a communication system in a first embodiment.

FIG. 2 A flowchart illustrating a flow of processing of a transceiver accommodating device in the first embodiment.

FIG. 3 A diagram illustrating a configuration example of a communication system in Modification 2 of the first embodiment.

FIG. 4 A flowchart illustrating a flow of processing of a transceiver accommodating device in a second embodiment.

FIG. 5 A diagram illustrating a configuration example of a communication system in a third embodiment.

FIG. 6 A sequence diagram illustrating a flow of communication system processing in the third embodiment.

FIG. 7 A diagram illustrating an example hardware configuration of a communication system in each embodiment.

### DESCRIPTION OF EMBODIMENTS

Hereinafter, embodiments of the present invention will be described with reference to the drawings.

### Overview

A communication system in an embodiment enables a telecommunication carrier (for example, authenticated control device) to change a related setting in which change in setting related to a transceiver that should not be operated by a user is to be restricted, monitors the related setting at a predetermined interval or at a timing when the related setting has been changed, and performs rewriting with preset information or blocks transmission in a case where a setting of the related setting is not a preset setting, thereby reducing an influence of operation against intention of the telecommunication carrier related to a business telecommunication facility installed in a user's home.

Hereinafter, specific configurations for implementing the above processing will be described.

### [Control From Authenticated Control Device]

Here, control from an authenticated control device includes, for example, any control from the authenticated control device described below.
Main signal interruption release (main signal transmission)
Main signal interruption (transmission interruption of main signal)
Stop feeding (block feeding) or perform feeding (permit feeding) of functional unit or device related to main signal
Setting value related to main signal or quality of main signal such as wavelength (optical frequency), wavelength width (frequency width), polarization, multivalued degree, or transmission scheme of main signal
Represent control related to setting and setting change of setting value that affects main signal itself to be controlled, other main signals that share the channel or the like with main signal or use adjacent channel, or quality of other main signals, setting value related to main signal or quality of main signal such as, for example, wavelength (optical frequency), wavelength width (frequency width), polarization, multivalued degree, or transmission scheme of main signal, and the like.

### First Embodiment

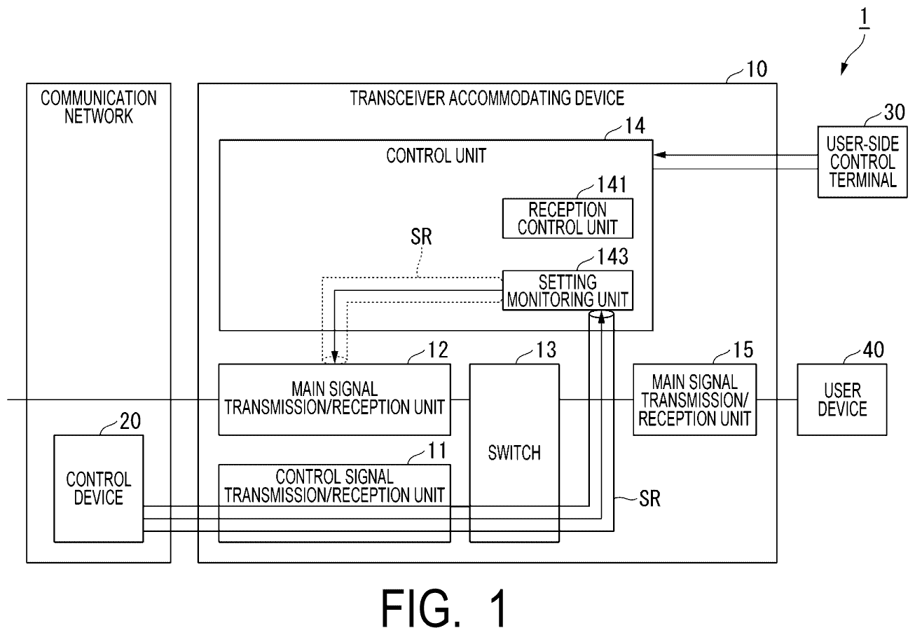

FIG. 1 is a diagram illustrating a configuration example of a communication system 1 in a first embodiment. The communication system 1 includes a transceiver accommodating device 10 and a control device 20. The communication system 1 is, for example, an optical transmission system in an all-photonics network (APN). A user device 40 is connected to the transceiver accommodating device 10. Note that a user-side control terminal 30 may be connected to the transceiver accommodating device 10 via a management port such as a serial bus. Note that the connection is not limited to the serial bus.

The transceiver accommodating device 10 is included in a user's home. The transceiver accommodating device 10 includes, for example, a white box switch in which software is installed, a transceiver for transmitting and receiving a main signal, and a transceiver for transmitting and receiving a control signal. The transceiver accommodating device 10 includes a control signal transmission/reception unit 11, a main signal transmission/reception unit 12, a switch 13, a control unit 14, and a main signal transmission/reception unit 15. The control unit 14 includes a reception control unit 141 and a setting monitoring unit 143.

In a case where the reception control unit 141 is in the transceiver accommodating device 10, handling in the transceiver accommodating device 10 regarding enabling/disabling communication with the control device 20 on the communication network side is fast.

In a case where the setting monitoring unit 143 is in the transceiver accommodating device 10, monitoring is faster as compared with a case where the setting monitoring unit 143 is in the control device 20 on the communication network side, and an instruction can be given even if a control signal is blocked.

The white box switch includes, as hardware, the control unit 14 of the white box switch such as a central processing unit (CPU), a control interface to the control unit 14, and the switch 13. The transceiver accommodating device 10 in the present embodiment is formed by combining the control signal transmission/reception unit 11, the main signal transmission/reception unit 12, and the main signal transmission/reception unit 15 with the white box switch. “A software executed on the control unit 14 includes, for example, a set of software of a network operating system (NOS) of a normal white box switch and a Goldstone or the like, a monitoring setting function, a block function, and the like described below.”

In the following description, in first to fourth embodiments, a configuration in which an NOS of a white box switch and software such as a setting function and a block function are installed in the white box switch will be described as an example. In a fifth embodiment, a configuration in which a Goldstone is installed in the white box switch will be further described as an example.

The control device 20 is disposed in a communication network. The control device 20 is, for example, a photonic gateway or a controller of the photonic gateway. The control device 20 controls a predetermined setting (related setting) (for example, setting of the wavelength of an optical signal of a main signal) that should not be changed in terms of service of the main signal transmission/reception unit 12 included in the transceiver accommodating device 10. For example, the control device 20 controls a setting or the like of the main signal transmission/reception unit 12 by transmitting a control signal to the transceiver accommodating device 10. Furthermore, the control device 20 may check the controlled setting or the like by receiving the response. Examples of the control content such as the setting of the main signal transmission/reception unit 12 include any of activation, stop, and reactivation of the main signal transmission/reception unit 12, a setting of a predetermined parameter, transmission start or stop of a main signal, parameter setting change, parameter setting deletion, block (any one of transmission stop, output intensity reduction, stop, reactivation, and power supply disconnection of the main signal transmission/reception unit 12, power supply disconnection of the transceiver accommodating device 10, and block on the communication network side), and the like.

The user-side control terminal 30 is a device operated by a user at a user's home where the transceiver accommodating device 10 is installed. The user-side control terminal 30 can access the transceiver accommodating device 10 and change the setting of the main signal transmission/reception unit 12 included in the transceiver accommodating device 10. The operation by which a user changes the setting of the main signal transmission/reception unit 12 by operating the user-side control terminal 30 includes operation against intention of the telecommunication carrier (for example, change and reading of the related setting of the main signal transmission/reception unit 12 (transceiver) and rewriting of related software (replacement and addition)). The user-side control terminal 30 includes an information processing device such as a personal computer.

The user device 40 transmits and receives a main signal to and from the opposing device via the transceiver accommodating device 10 and the communication network. The user device 40 is customer premises equipment (CPE). The user device 40 is connected to a transceiver or a network interface card (NIC) that transmits and receives a main signal on the user side included in the transceiver accommodating device 10. For example, the user device 40 is connected to a main signal transmission/reception unit 15 that communicates (transmits and receives) a main signal with a user side in the transceiver accommodating device 10.

Next, a specific configuration of the transceiver accommodating device 10 will be described.

The control signal transmission/reception unit 11 is a transceiver for a control signal. The control signal transmission/reception unit 11 transmits and receives a control signal to and from the control device 20 in the communication network. Note that the control signal transmitted and received between the control signal transmission/reception unit 11 and the control device 20 in the communication network may be an electric signal or an optical signal. In a case where the control signal is wavelength-division-multiplexed with a main signal, the control signal is an optical signal. The control signal transmission/reception unit 11 may use another communication network (not illustrated) instead of the communication network. The control signal transmission/reception unit 11 may be connected from a management port of the transceiver accommodating device 10 via a dongle or the like connected to another communication network (not illustrated).

The control signal transmitted from the control device 20 includes information instructing a predetermined parameter of the main signal transmission/reception unit 12 of the transceiver accommodating device 10. The predetermined parameter of the main signal transmission/reception unit 12 is, for example, (light emission or extinction (for example, tx-dis false/true), light intensity, wavelength (wavelength grid (for example, 100-ghz|50-ghz|33-ghz|25-ghz|12-5-ghz|6-25-ghz or the like), optical frequency, channel number), or the like. The predetermined parameter of the main signal transmission/reception unit 12 may include information such as a transmission format (for example, bpsk|dp-bpsk|qpsk|dp-qpsk|8-qam|dp-8-qam|16-qam|dp-16-qam|32-qam|dp-32-qam|64-qam|dp-64-qam or the like), a line rate (for example, 100 g|200 g|300 g|400 g or the like), and a forward error correction (FEC) type (for example, Staircase (sc)-fec|Concatenated (c)fec|Open (o)fec or the like).

The control signal transmission/reception unit 11 outputs the received control signal to the switch 13. Note that in a case where the control signal is an optical signal, the control signal transmission/reception unit 11 converts the received control signal into an electric signal and outputs the electric signal to the switch 13. Although the control signal transmission/reception unit 11 is illustrated in the drawing as a configuration in which signals such as, for example, optical signals are exchanged with the control device 20 in the communication network and connected to the reception control unit 141 via the switch 13, in a case where there is a serial, a universal serial bus (USB), or an Ethernet interface in the management port of the transceiver accommodating device 10, the control signal transmission/reception unit 11 may be a transceiver or a dongle that is connected to the serial, the USB, or the Ethernet interface and can communicate with the control device 20 on the communication network side, and the transceiver or the dongle may be replaceable.

The main signal transmission/reception unit 12 is a transceiver for main signal. The main signal transmission/reception unit 12 transmits and receives a main signal such as an optical signal to and from the opposing device via a communication network. The main signal transmission/reception unit 12 converts the received main signal into an electric signal and outputs the electric signal to the switch 13. The main signal transmission/reception unit 12 is usually a replaceable transceiver.

In a case where the main signal transmission/reception unit 12 is an analog coherent optics (ACO) transceiver, a digital signal processing unit (not illustrated) is included between the main signal transmission/reception unit 12 and the switch 13. The digital signal processing unit performs signal processing such as optical transport network (OTN) framing, FEC, modulation/demodulation processing, and optical degradation correction on the electric signal output from the main signal transmission/reception unit 12.

In a case where the main signal transmission/reception unit 12 is a digital coherent optics (DCO) transceiver, the main signal transmission/reception unit 12 includes a digital signal processing unit. The digital signal processing unit of the main signal transmission/reception unit 12 performs OTN framing, FEC, modulation/demodulation processing, optical degradation correction, and the like.

In the following description, assume that a signal of the control signal transmission/reception unit 11 and a signal of the main signal transmission/reception unit 12 are multiplexed by wavelength division multiplexing or the like and transmitted through the same optical fiber (for example, optical fiber or transmission path).

The main signal transmission/reception unit 15 transmits and receives a main signal to and from the user device 40. The main signal transmission/reception unit 15 is a transceiver or an NIC.

The switch 13 connects the main signal transmission/reception unit 12 and the main signal transmission/reception unit 15, and connects the control signal transmission/reception unit 11 and the control unit 14. The switch 13 connects the main signal transmission/reception unit 12 and the control unit 14 in a case where a control signal is communicated using a main signal itself, a frame carrying the main signal, or an AMCC. For example, the switch 13 connects the main signal transmission/reception unit 12 and the main signal transmission/reception unit 15 to conduct a main signal. For example, the switch 13 transfers a control signal transmitted from the control device 20 to the control unit 14 by connecting the control signal transmission/reception unit 11 and the control unit 14. In this manner, the switch 13 also functions as an adapter for passing the control signal transmitted from the control device 20 to the control unit 14.

The control unit 14 performs control related to at least the main signal transmission/reception unit 12. The control unit 14 includes one or more processors such as CPUs and one or more memories. The control unit 14 implements functions of the reception control unit 141 and the setting monitoring unit 143 by the one or more processors executing a program. Here, the reception control unit 141 and the setting monitoring unit 143 correspond to the monitoring setting function described above.

Some or all of the functions of the control unit 14 may be implemented using hardware such as an application specific integrated circuit (ASIC), a programmable logic device (PLD), or a field programmable gate array (FPGA). The above program may be recorded in a computer-readable recording medium. The computer-readable recording medium is, for example, a portable medium such as a flexible disk, a magneto-optical disk, a read only memory (ROM), a compact disc read only memory (CD-ROM), or a semiconductor storage device (for example, a solid state drive (SSD)), or a storage device such as a hard disk or a semiconductor storage device built in a computer system. The above program may be transmitted via a telecommunication line.

Before communication conduction between the transceiver accommodating device 10 and the opposing device is permitted, the reception control unit 141 desirably constructs a control signal path SR with the control device 20 via the control signal transmission/reception unit 11 and the switch 13, the control signal path SR enabling access to a related setting in which change in setting related to at least the main signal transmission/reception unit 12 is to be restricted. For example, the reception control unit 141 constructs the control signal path SR between the control device 20 and the setting monitoring unit 143 and between the main signal transmission/reception unit 12 and the setting monitoring unit 143 in the control unit 14.

Note that, in a case where the environment between the control unit 14 and the main signal transmission/reception unit 12 is secure, the reception control unit 141 may not construct the control signal path SR in a path indicated by the broken line between the main signal transmission/reception unit 12 and the setting monitoring unit 143 in the control unit 14 illustrated in FIG. 1. Here, the secure environment between the control unit 14 and the main signal transmission/reception unit 12 is an environment in which at least exchange of information between the control unit 14 and the main signal transmission/reception unit 12 is not intercepted or data is not falsified. Furthermore, it is more desirable to permit a predetermined setting after, not only the control signal path SR is constructed, but also it is determined that the control unit 14 receives only control from the reception control unit 141. This is because there is a possibility that an unintended main signal is conducted if any of them is not completed and permitted. In this manner, the control unit 14 permits communication conduction of a main signal after login is restricted. However, the present invention is not limited thereto in a case where the setting monitoring unit 143 performs blocking in advance. The control signal path SR enables access to a predetermined related setting in which change or reading of a setting related to the main signal transmission/reception unit 12 is to be restricted.

Here, although the control signal path SR is desirably a highly secure communication path such as a virtual private network (VPN), the control signal path SR is not necessarily required to be a highly secure communication path as long as the control signal path SR is a control signal path that enables access to a related setting, and an unauthenticated device (for example, user-side control terminal 30) cannot access functional units (for example, reception control unit 141, overwrite instruction unit 142, and setting monitoring unit 143) included in the transceiver accommodating device 10. By using such a control signal path SR, exchange between functional units is prevented from being intercepted or falsified by a malicious user. Furthermore, the reception control unit 141 notifies the control device 20 of or responds to the control device 20 with a setting state (setting execution completion or setting value).

The setting monitoring unit 143 sets the main signal transmission/reception unit 12 in accordance with an instruction from the control device 20 or the user-side control terminal 30. Further, the setting monitoring unit 143 monitors a related setting at a predetermined interval (for example, polling), and determines whether the setting of the related setting (for example, each setting value of the related setting) is a preset setting. The preset setting represents a value that should be originally set by the telecommunication carrier in the related setting. If the setting of the related setting is not the preset setting, the setting monitoring unit 143 performs rewriting with preset information. The setting monitoring unit 143 may monitor the related setting and determine whether the setting of the related setting (for example, each setting value of the related setting) is the preset setting in response to change in related setting. If the setting of the related setting is the preset setting, the setting monitoring unit 143 permits conduction between the main signal transmission/reception unit 12 and the control device 20 in the communication network.

The preset information represents a value that should be originally set by the telecommunication carrier as the related setting. The predetermined interval is desirably shorter than or equal to a time until, for example, malicious change of a setting is reflected in output of the main signal transmission/reception unit 12. The predetermined interval may be shorter than or equal to a time during which communication block of the main signal transmission/reception unit 12 due to malicious change in setting or an influence on a main signal of another user due to output of the main signal transmission/reception unit 12 can be allowed. In this manner, the setting monitoring unit 143 restores the related setting of the control signal transmission/reception unit 11 to a desired value by rewriting the related setting with the preset information at the predetermined interval.

The reception control unit 141 may communicate the related setting with the main signal transmission/reception unit 12 using a predetermined client signal, a GCC channel for control signal, an auxiliary management and control channel (AMCC), or the like. In this case, the reception control unit 141 may construct the control signal path SR between the main signal transmission/reception unit 12 and the control device 20. In a case where the control signal path SR is constructed between the main signal transmission/reception unit 12 and the control device 20, the reception control unit 141 constructs the control signal path SR after communication conduction between the transceiver accommodating device 10 and the opposing device (not illustrated) is permitted. Note that in a case where the control signal is not time-divisionally multiplexed in a format, for example, in which the control signal is frame-multiplexed into a user signal or in a format, for example, of a frame carrying a user signal (for example, generic communications channel (GCC)) or the like, the user signal may be discarded by the switch 13 or a predetermined functional unit other than the switch 13.

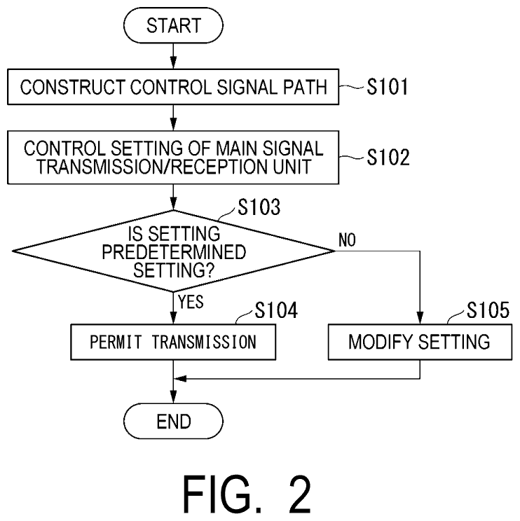

FIG. 2 is a flowchart illustrating a flow of processing of the transceiver accommodating device 10 in the first embodiment.

The reception control unit 141 constructs the control signal path SR with the control device 20 before communication conduction between the transceiver accommodating device 10 and the opposing device is permitted (step S101). Specifically, in FIG. 1, the reception control unit 141 constructs the control signal path SR between the control device 20 and the setting monitoring unit 143 and between the setting monitoring unit 143 and the main signal transmission/reception unit 12. As a result, setting is possible even if there is interference, and further, if a user cannot use the control signal path SR and setting the related setting from a path other than the control signal path SR is difficult, malicious control from a user can be prevented.

The control signal transmission/reception unit 11 receives a control signal transmitted from the control device 20 via the control signal path SR. The control signal transmission/reception unit 11 outputs the received control signal to the switch 13. The control signal includes, for example, information instructing a predetermined parameter of the main signal transmission/reception unit 12 of the transceiver accommodating device 10. It may be a monitoring instruction or designation of a monitoring frequency if the predetermined parameter is held by the setting monitoring unit 143.

The switch 13 transfers the received control signal to the control unit 14 by connecting the control signal transmission/reception unit 11 and the control unit 14. The control signal output from the switch 13 is input to the setting monitoring unit 143 in the control unit 14 via the control signal path SR.

The setting monitoring unit 143 controls the setting of the main signal transmission/reception unit 12 in accordance with the control signal (step S102). Thereafter, the reception control unit 141 notifies the control device 20 of or responds to the control device 20 with a control signal indicating a setting state (setting execution completion or setting value) via the control signal transmission/reception unit 11. At this time, the reception control unit 141 may notify the control device 20 or respond to the control device 20 via the control signal path SR, or may notify the control device 20 or respond to the control device 20 via another path. Note that the setting monitoring unit 143 controls the setting of the main signal transmission/reception unit 12 in accordance with an instruction even in a case where the instruction to change the setting is given by the user-side control terminal 30 from the outside. Thereafter, the reception control unit 141 notifies the control device 20 of or responds to the control device 20 with a control signal indicating a setting state (setting execution completion or setting value) via the control signal transmission/reception unit 11.

The setting monitoring unit 143 determines whether the related setting is a preset setting at a predetermined interval or in response to change in related setting (step S103). If it is determined that the related setting is the preset setting (step S103—YES), the setting monitoring unit 143 permits conduction between the main signal transmission/reception unit 12 and the control device 20 in the communication network (step S104). As a result, control can be performed such that communication is enabled between the opposing device via the control device 20 and the main signal transmission/reception unit 12. As a result, communication based on a main signal is enabled between the opposing device via the control device 20 and the main signal transmission/reception unit 12.

If it is determined that the related setting is not the preset setting (step S103—NO), the setting monitoring unit 143 rewrites the related setting of the main signal transmission/reception unit 12 with preset information (step S105). As a result, even if the related setting is changed by a user, the setting is restored to a setting based on the preset information. Thereafter, the reception control unit 141 notifies the control device 20 of or responds to the control device 20 with a control signal indicating a setting state (setting execution completion or setting value) via the control signal transmission/reception unit 11.

According to the communication system 1 formed as described above, the transceiver accommodating device 10 includes: the main signal transmission/reception unit 12 that transmits and receives a main signal to and from an opposing device via a communication network in which the control device 20 is disposed; and the setting monitoring unit 143 that monitors a related setting in which change of a setting related to the main signal transmission/reception unit 12 is to be restricted, and performs rewriting with preset information in a case where a setting of the related setting is not a preset setting. As a result, even if a user operates the user-side control terminal 30 to change the related setting, rewriting can be performed with preset information.

Therefore, an influence of operation against intention of a telecommunication carrier regarding a business telecommunication facility installed in a user's home can be reduced.

Furthermore, in the transceiver accommodating device 10, the setting in the transceiver accommodating device 10 by a user is not blocked, but change of some settings to be managed on the network side is effectively reduced by monitoring. As described above, the transceiver accommodating device 10 accepts setting change by a user for a setting that the user may change while reducing only change of a setting that the user should not operate. Therefore, the degree of freedom of changing a setting other than a setting that should not be changed and changing a software configuration is left for a user.

Further, in the transceiver accommodating device 10, even if there is no instruction from the outside, a related setting is monitored at a predetermined interval or in response to change in related setting, and rewriting may be performed with preset information in a case where a setting of the related setting is not a preset setting. In this case, since processing can be performed exclusively in the transceiver accommodating device 10, there are few loopholes, and immediate handling is possible.

### Modification 1

In the above-described embodiment, the configuration has been described in which a control signal transmitted from the control device 20 is received via the control signal transmission/reception unit 11, but the main signal transmission/reception unit 12 may exchange a control signal using a predetermined client signal, a GCC channel for control signal, an AMCC, or the like. In such a configuration, the reception control unit 141 may construct the control signal path SR between the main signal transmission/reception unit 12 and the control device 20.

In a case where the control signal path SR is constructed between the main signal transmission/reception unit 12 and the control device 20, the reception control unit 141 constructs the control signal path SR after communication conduction between the transceiver accommodating device 10 and the opposing device (not illustrated) is permitted. Note that in a case where the control signal is not time-divisionally multiplexed in a format, for example, in which the control signal is frame-multiplexed into a user signal or in a format, for example, of a frame carrying a user signal (for example, generic communications channel (GCC)) or the like, the user signal may be discarded by the switch 13 or a predetermined functional unit other than the switch 13.

In a case where the control signal path SR is constructed between the main signal transmission/reception unit 12 and the control device 20, the reception control unit 141 is performed after communication conduction between the transceiver accommodating device 10 and the opposing device is permitted. The control unit 14 desirably constructs the control signal path SR with the control device 20 via the control signal transmission/reception unit 11 and the switch 13 before communication conduction of a main signal among the user device 40, the main signal transmission/reception unit 12, and the communication network is permitted. Furthermore, it is more desirable to permit a predetermined setting after, not only the control signal path SR is constructed, but also it is determined that the control unit 14 receives only control from the reception control unit 141. This is because there is a possibility that an unintended main signal is conducted if any of them is not completed and permitted. In this manner, the control unit 14 permits communication conduction of a main signal after setting is performed. However, the present invention is not limited thereto in a case where a setting monitoring unit to be described below performs blocking in advance. The control signal path SR enables access to a predetermined related setting in which change or reading of a setting related to the main signal transmission/reception unit 12 is to be restricted. Here, the control signal path SR is desirably a highly secure communication path, but may be any control signal path that enables access to a related setting. The security of the control signal path SR may not be necessarily high. The highly secure communication path is, for example, a VPN. This makes it possible to conceal communication content of control to a user.

### Modification 2

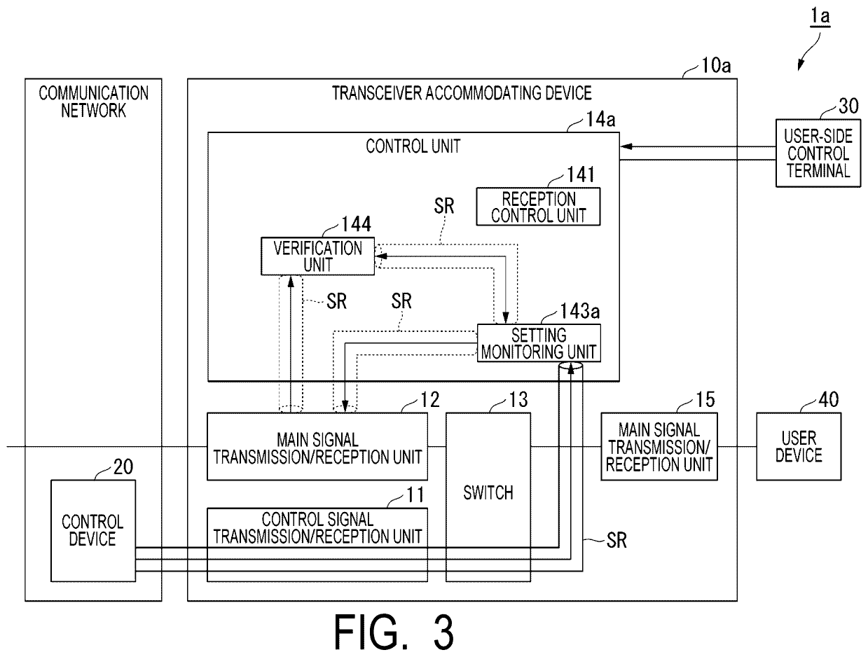

The transceiver accommodating device 10 may be formed as illustrated in FIG. 3. FIG. 3 is a diagram illustrating a configuration example of a communication system 1a according to Modification 2 of the first embodiment. The communication system 1a includes a transceiver accommodating device 10a and the control device 20. The communication system 1a is different from the communication system 1 in that the transceiver accommodating device 10a is included instead of the transceiver accommodating device 10. The other components of the communication system 1a are similar to those of the communication system 1. Hereinafter, differences from the communication system 1 will be mainly described.

The transceiver accommodating device 10a includes the control signal transmission/reception unit 11, the main signal transmission/reception unit 12, the switch 13, a control unit 14a, and the main signal transmission/reception unit 15. The control unit 14a performs control related to at least the main signal transmission/reception unit 12. The control unit 14a has a configuration similar to that of the control unit 14. The control unit 14a implements functions of the reception control unit 141, a setting monitoring unit 143a, and a verification unit 144 by one or more processors executing a program. Here, the reception control unit 141 and the setting monitoring unit 143a correspond to the monitoring setting function described above, and the setting monitoring unit 143a and the verification unit 144 correspond to the block function.

The reception control unit 141 constructs the control signal path SR between the control device 20 and the setting monitoring unit 143a in the control unit 14a, between the main signal transmission/reception unit 12 and the setting monitoring unit 143a in the control unit 14a, between the main signal transmission/reception unit 12 and the verification unit 144 in the control unit 14a, and between the setting monitoring unit 143a and the verification unit 144 in the control unit 14a. Note that, in a case where the environment in the control unit 14a is secure, the reception control unit 141 may not construct the control signal path SR in a path indicated by the broken line between the setting monitoring unit 143a and the verification unit 144 in in the control unit 14a illustrated in FIG. 3. Here, the secure environment in the control unit 14a is an environment in which at least exchange of information performed inside the control unit 14a is not intercepted or data is not falsified. Note that, in a case where the environment between the control unit 14a and the main signal transmission/reception unit 12 is secure, the reception control unit 141 may not construct the control signal path SR in a path indicated by the broken line between the main signal transmission/reception unit 12 and the setting monitoring unit 143a in the control unit 14a illustrated in FIG. 3 and a path indicated by the broken line between the main signal transmission/reception unit 12 and the verification unit 144 in the control unit 14a illustrated in FIG. 3. Here, the secure environment between the control unit 14a and the main signal transmission/reception unit 12 is an environment in which at least exchange of information between the control unit 14a and the main signal transmission/reception unit 12 is not intercepted or data is not falsified. The setting monitoring unit 143a and the verification unit 144 exchange a verification result and a monitoring result.

The verification unit 144 verifies whether rewriting on a related setting is valid. Here, “valid” includes that the value of the related setting is a predetermined value, that writing can be performed on the related setting, that the writing is not abnormal, that a device other than the control device 20 is not trying to rewrite the held setting value, and the like. The verification unit 144 desirably checks whether an appropriate setting value of the appropriate main signal transmission/reception unit 12 is set.

The setting monitoring unit 143a blocks transmission between the main signal transmission/reception unit 12 and the control device 20 in the communication network in a case where it is determined not to be valid as a result of the verification by the verification unit 144. Note that the blocking may be executed in a case where preset information cannot be set. The setting monitoring unit 143a gives an alarm of an abnormality from the transceiver accommodating device 10a, but may perform blocking in response to the control device 20 on the communication network side not being able to normally communicate with the transceiver accommodating device 10a or an inflow of abnormal traffic into the communication network. The abnormal traffic is traffic incompatible with a value of a predetermined related setting. For example, if the value of the related setting is a wavelength, the abnormal traffic is an inappropriate wavelength, and if the value of the related setting is an intensity, the abnormal traffic is an inappropriate high intensity or low intensity. Further, the setting monitoring unit 143a may hold setting information obtained by receiving a control signal including a setting instruction transmitted from the control device 20 or performing snooping or the like, and block the held setting information in response to failure of setting, setting checking, or the like, notification or detection of a setting abnormality, rewriting of the setting from a path other than a path in the communication network (for example, path other than the control signal path SR), or occurrence of a phenomenon of an attempt to perform rewriting. Further, the setting monitoring unit 143a may perform blocking if there is no setting notification or response, or may perform blocking if there is a setting failure or abnormality.

Here, examples of the method of blocking conduction of the transceiver accommodating device 10a include at least one of the following methods: reducing optical output of the main signal transmission/reception unit 12 to a negligible level (writing of a register or the like), turning off optical transmission (input to a hard pin or writing of a corresponding register or the like), stopping the main signal transmission/reception unit 12, reactivating the main signal transmission/reception unit 12, disconnecting the power supply of the main signal transmission/reception unit 12, turning off feeding of the main signal transmission/reception unit 12, turning off the power supply of the transceiver accommodating device 10a, blocking a signal on the communication network side, or the like.

The setting monitoring unit 143a (application) that is implemented in advance by software in the control unit 14a performs predetermined setting on the main signal transmission/reception unit 12 on the basis of only a control signal from the reception control unit 141. For example, a setting monitoring unit (software changed for the present embodiment for South-TAI, for example, in a Goldstone) implemented in advance by software in the control unit 14a changes and reads a predetermined related setting of the main signal transmission/reception unit 12 on the basis of only a control signal from the reception control unit 141. Here, the setting monitoring unit 143a does not perform execution on the basis of control from the user-side control terminal 30.

As a result, an influence of operation against intention of the telecommunication carrier (change that should not be operated by a user) on the service provision can be reduced. Operation other than the operation against intention of the telecommunication carrier may be controlled by a user. Compared to a case where the setting monitoring unit 143a or the like is implemented in the control signal transmission/reception unit 11 or the main signal transmission/reception unit 12 by software or the like, there are more operation resources in implementation in the control unit 14a, and thus, advanced control is possible. Furthermore, replacing the control is easy, and responding can be performed more quickly as compared with the third embodiment (described below). Furthermore, handling can be performed without communication with the communication network being frequently executed.

### Second Embodiment

In the second embodiment, as an example, a configuration will be described in which, in a setting monitoring unit included in a transceiver accommodating device, conduction with a control device in a communication network is blocked if a related setting of a main signal transmission/reception unit is not a preset setting. A system configuration in the second embodiment is similar to that in FIG. 1. Differences from the first embodiment will be mainly described.

A transceiver accommodating device 10 in the second embodiment includes a reception control unit 141 and a setting monitoring unit 143 as functions implemented by a control unit 14.

In a case where the reception control unit 141 is in the transceiver accommodating device 10, handling in the transceiver accommodating device 10 regarding enabling/disabling communication with a control device 20 on the communication network side is fast.

In a case where the reception control unit 141 and the setting monitoring unit 143 are in the transceiver accommodating device 10, handling in the transceiver accommodating device 10 regarding enabling/disabling communication with the control device 20 on the communication network side is fast.

In a case where the setting monitoring unit 143 including a block function is in the transceiver accommodating device 10, blocking is quickly performed if an abnormality is detected in the setting monitoring unit 143 or if a detected abnormality cannot be corrected.

In a case where the setting monitoring unit 143 including a block function is in the transceiver accommodating device 10 and receives a completion response to an instruction, blocking is quickly performed if an abnormality is detected in the setting monitoring unit 143 or if a detected abnormality cannot be corrected.

If a block condition is satisfied, the setting monitoring unit 143 in the second embodiment blocks transmission between the main signal transmission/reception unit 12 and the control device 20 in the communication network. The block condition is a condition for blocking conduction between the main signal transmission/reception unit 12 and the control device 20 in the communication network. The block condition is, for example, that one of the following conditions is satisfied. Examples of the block condition includes a case where the setting of the related setting is not a preset setting, a case where the related setting cannot be rewritten by the setting monitoring unit 143, a case where the communication network side control device 20 cannot normally communicate with the transceiver accommodating device 10, a case where there is an inflow of abnormal traffic, a case where setting, setting checking, or the like cannot be performed on setting information obtained by receiving a control signal including a setting instruction transmitted from the control device 20, snooping, or the like, a case where the setting is rewritten from a path other than a path of the communication network (for example, path other than a control signal path SR), a case where a phenomenon of an attempt to perform rewriting occurs, a case where there is no setting notification or response, a case where a setting failure or abnormality occurs, and the like.

The setting monitoring unit 143 of the transceiver accommodating device 10 rewrites the related setting with preset information. At this time, the related setting cannot be rewritten with preset information due to some trouble in some cases. The some trouble is, for example, a case where update of the related setting is disabled due to setting change by a user. In such a case, the setting monitoring unit 143 cannot rewrite the related setting. Therefore, if the related setting cannot be rewritten by the setting monitoring unit 143, the setting monitoring unit 143 of the transceiver accommodating device 10 in the second embodiment blocks transmission between the main signal transmission/reception unit 12 and the control device 20 in the communication network.

Note that the setting monitoring unit 143 may detect success or failure of rewriting by output to the standard output inside the transceiver accommodating device 10, a log, or the like. If the rewriting is successful, the setting monitoring unit 143 does nothing in particular. On the other hand, if the rewriting is not successful, the setting monitoring unit 143 blocks transmission between the main signal transmission/reception unit 12 and the control device 20 in the communication network.

Here, examples of the method of blocking conduction of the transceiver accommodating device 10 in the second embodiment include at least one of the following methods: reducing optical output of the main signal transmission/reception unit 12 to a negligible level (writing of a register or the like), turning off optical transmission (input to a hard pin or writing of a corresponding register or the like), stopping the main signal transmission/reception unit 12, reactivating the main signal transmission/reception unit 12, disconnecting the power supply of the main signal transmission/reception unit 12, blocking conduction of a main signal in the main signal transmission/reception unit 12 between the user device 40 and the control device 20, turning off feeding of the main signal transmission/reception unit 12, turning off the power supply of the transceiver accommodating device 10, blocking a signal on the communication network side, or the like. Note that the control device 20 may also include a configuration for blocking conduction.

If any one of a case where setting cannot be performed, a case where a setting value cannot be set as set, a case where a held setting value is changed by control other than control of the control device 20, and a case where blocking is performed is satisfied, the reception control unit 141 notifies the control device 20 of or responds to the control device 20 with the fact.

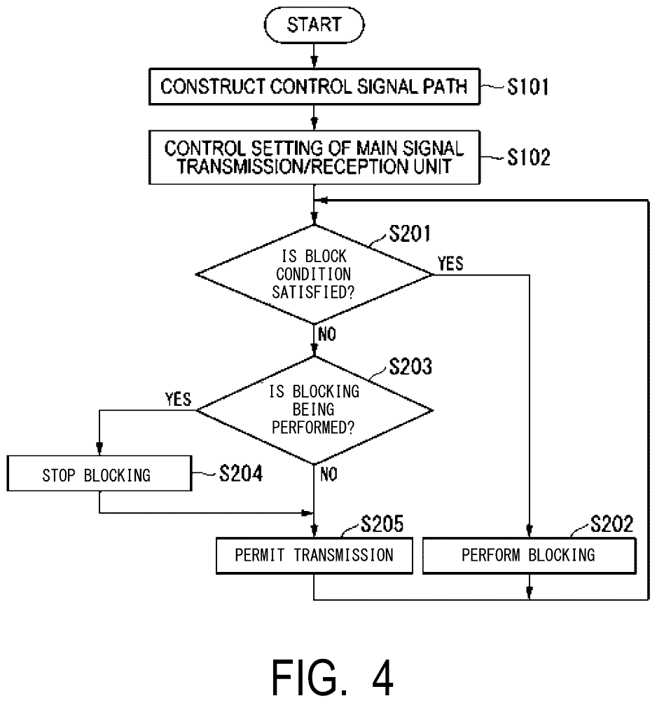

FIG. 4 is a flowchart illustrating a flow of processing of the transceiver accommodating device 10 in the second embodiment. In FIG. 4, processing similar to that in FIG. 2 is denoted by a step number similar to that in FIG. 2, and the description thereof may be omitted.

If the processing from step S101 to step S102 is executed and the processing of step S102 ends, the setting monitoring unit 143 determines whether the block condition is satisfied (step S201). Here, for example, assume that the setting monitoring unit 143 determines whether a changed related setting is a preset setting in response to change in related setting in the processing of step S102. If the changed related setting is a preset setting, the setting monitoring unit 143 determines that the block condition is not satisfied. If the changed related setting is not the preset setting, the setting monitoring unit 143 determines that the block condition is satisfied.

If it is determined that the block condition is satisfied (step S201—YES), the setting monitoring unit 143 determines whether conduction between the main signal transmission/reception unit 12 and the control device 20 in the communication network is currently blocked (step S203). If the setting monitoring unit 143 determines that the conduction between the main signal transmission/reception unit 12 and the control device 20 in the communication network is blocked (step S203—YES), the setting monitoring unit 12 stops the blocking of the conduction between the main signal transmission/reception unit and the control device 20 in the communication network (step S204). Thereafter, the setting monitoring unit 143 permits the conduction between the main signal transmission/reception unit 12 and the control device 20 in the communication network (step S205). If the setting monitoring unit 143 determines that the conduction between the main signal transmission/reception unit 12 and the control device 20 in the communication network is not blocked (step S203—NO), the setting monitoring unit 12 permits the conduction between the main signal transmission/reception unit and the control device 20 in the communication network (step S205).

According to the communication system 1 in the second embodiment formed as described above, use of the transceiver accommodating device 10 can be stopped if setting is performed such that rewriting by a user is not allowed. As a result, an influence of operation against intention of a telecommunication carrier regarding a business telecommunication facility installed can be reduced.

### Third Embodiment

In the third embodiment, a configuration will be described in which a control device disposed in a communication network includes a setting monitoring unit.

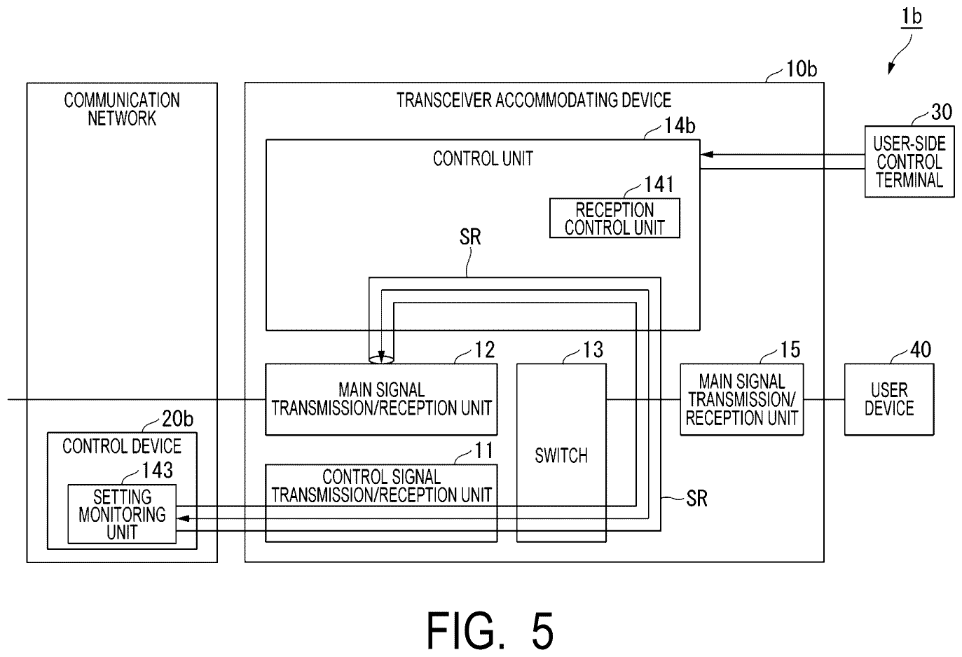

FIG. 5 is a diagram illustrating a configuration example of a communication system 1b according to the third embodiment. The communication system 1b includes a transceiver accommodating device 10b and a control device 20b. A user device 40 is connected to the transceiver accommodating device 10b. Note that a user-side control terminal 30 may be connected to the transceiver accommodating device 10b via a management port such as a serial bus. Note that the connection is not limited to the serial bus.

The transceiver accommodating device 10b is included in a user's home. The transceiver accommodating device 10b includes, for example, a white box switch in which software is installed, a transceiver for transmitting and receiving a main signal, and a transceiver for transmitting and receiving a control signal. Further, the transceiver accommodating device 10b responds with a setting value of a related setting in accordance with a control signal including a notification instruction of the setting value of the related setting transmitted from the control device 20b at a predetermined interval. The notification instruction includes an instruction to request notification of a value set in the related setting. The transceiver accommodating device 10b includes the control signal transmission/reception unit 11, the main signal transmission/reception unit 12, the switch 13, a control unit 14b, and the main signal transmission/reception unit 15. The control unit 14b includes a reception control unit 141.

In a case where the reception control unit 141 is in the transceiver accommodating device 10b, handling in the transceiver accommodating device 10b regarding enabling/disabling communication with the control device 20b on the communication network side is fast.

If a setting monitoring unit 143 is on the communication network side (for example, in the control device 20b on the communication network side), handling on the communication network side if an abnormality is detected by the setting monitoring unit 143 or if a detected abnormality cannot be corrected, such as, for example, correction of the abnormality by the reception control unit 141 is more quickly performed.

The control unit 14b performs control related to at least the main signal transmission/reception unit 12. The control unit 14b has a configuration similar to that of the control unit 14. The control unit 14b implements a function of the reception control unit 141 by one or more processors executing a program. Here, the reception control unit 141 corresponds to the monitoring setting function described above. The reception control unit 141 responds to the control device 20b with a value set in the related setting in accordance with a notification instruction from the control device 20b. Furthermore, in response to change in related setting, the reception control unit 141 responds to the control device 20b with a value of the changed related setting.

The reception control unit 141 constructs a control signal path SR between the control device 20b and the main signal transmission/reception unit 12.

The control device 20b includes the setting monitoring unit 143. The setting monitoring unit 143 included in the control device 20b and the transceiver accommodating device 10b may communicate with each other via the control signal path SR. The setting monitoring unit 143 generates a notification instruction. The setting monitoring unit 143 acquires a value of the related setting and monitors the related setting by transmitting the generated notification instruction to the transceiver accommodating device 10b. The setting monitoring unit 143 monitors the related setting at a predetermined interval or in response to a response from the reception control unit, and performs rewriting with preset information in a case where the setting of the related setting is not the preset setting. Here, as a method in which the setting monitoring unit 143 rewrites the related setting with preset information, it is conceivable to transmit a control signal including an instruction to rewrite the value of the related setting and a value of the related setting with which rewriting is to be performed from the setting monitoring unit 143 to the transceiver accommodating device 10b.

Note that the setting monitoring unit 143 is not limited to being included in the control device 20b, and may be included anywhere in the communication network. In this case, the vicinity of the control device 20b or the inside or the vicinity of an operation system that controls the communication network is preferable. However, in a case where the setting monitoring unit 143 is not included in the control device 20b, it is assumed that the communication network is formed to be hardly cracked. In a case where the setting monitoring unit 143 blocks a main signal output from the main signal transmission/reception unit 12 of the transceiver accommodating device 10b in the communication network, the setting monitoring unit 143 is desirably disposed on a flow line of the main signal. In a case where the setting monitoring unit 143 instructs the main signal transmission/reception unit 12 to stop or disconnect the power supply, causes the transceiver accommodating device 10b to turn off the power supply of the main signal transmission/reception unit 12, causes the switch 13 to block signal conduction between the main signal transmission/reception unit 12 on the communication network side and the main signal transmission/reception unit 15 on the user device 40 side, or turns off the power supply of the transceiver accommodating device 10b itself, the setting monitoring unit 143 is desirably included in the control device 20b.

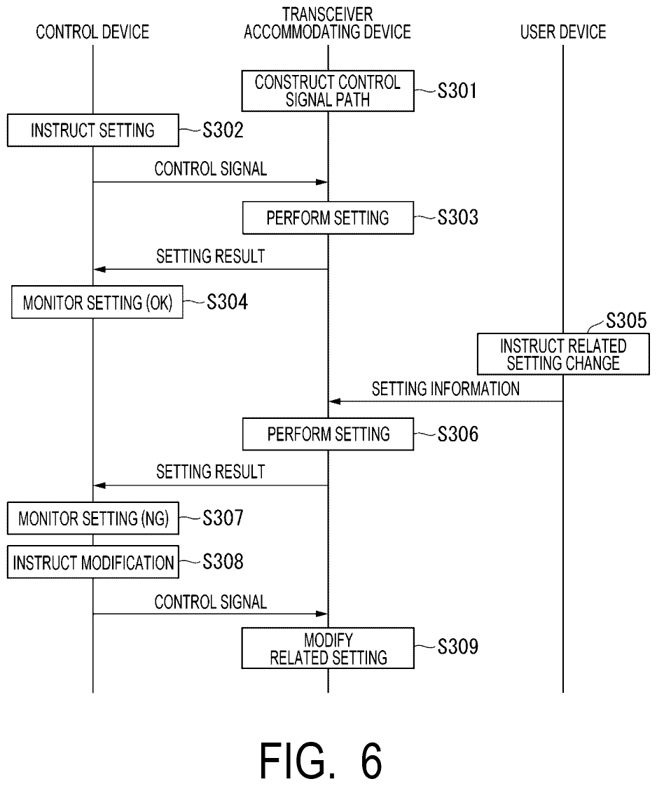

FIG. 6 is a sequence diagram illustrating a flow of processing performed by the communication system 1b according to the third embodiment.

The reception control unit 141 of the transceiver accommodating device 10b constructs the control signal path SR with the control device 20b before communication conduction between the transceiver accommodating device 10b and the opposing device is permitted (step S301). As a result, even if there is interference, the interference can be reduced, and further, malicious control from a user can be prevented.

The setting monitoring unit 143 of the control device 20b generates a control signal including information instructing a predetermined parameter of the main signal transmission/reception unit 12 of the transceiver accommodating device 10b. The setting monitoring unit 143 transmits the generated control signal to the transceiver accommodating device 10b (step S302). The control signal transmitted from the transceiver accommodating device 10b is received by the control signal transmission/reception unit 11 via the control signal path SR constructed between the transceiver accommodating device 10b and the control device 20b. The control signal transmission/reception unit 11 converts the received control signal into an electric signal and outputs the electric signal to the switch 13. The control signal output to the switch 13 is input to the main signal transmission/reception unit 12 via the control signal path SR

The main signal transmission/reception unit 12 controls the setting of the main signal transmission/reception unit 12 in accordance with the input control signal (step S303). Thereafter, the reception control unit 141 notifies the control device 20b of or responds to the control device 20b with a control signal indicating a setting state (setting execution completion or setting value) via the control signal transmission/reception unit 11. The setting monitoring unit 143 of the control device 20b acquires the control signal transmitted from the transceiver accommodating device 10b. The setting monitoring unit 143 monitors a setting by determining whether the setting of the related setting is a preset setting on the basis of information indicating a setting state included in the acquired control signal (step S304). Here, assume that the setting of the related setting is a preset setting.

Assume that, thereafter, a user operates the user-side control terminal 30 to access the transceiver accommodating device 10b. The user may operate the user-side control terminal 30 to give an instruction to change the related setting of the main signal transmission/reception unit 12. For example, the user-side control terminal 30 may attempt intrusion of a computer virus. For example, the user-side control terminal 30 may attempt to update the software (step S305). The reception control unit 141 changes the related setting of the main signal transmission/reception unit 12 to a setting according to the instruction from the user-side control terminal 30 (step S306). As a result, even if the user makes malicious setting change, the related setting of the main signal transmission/reception unit 12 is changed to the setting according to the instruction from the user-side control terminal 30. Thereafter, the reception control unit 141 notifies the control device 20b of or responds to the control device 20b with a control signal indicating a setting state (setting execution completion or setting value) via the control signal transmission/reception unit 11.

The setting monitoring unit 143 of the control device 20b acquires the control signal transmitted from the transceiver accommodating device 10b. The setting monitoring unit 143 monitors a setting by determining whether the setting of the related setting is a preset setting on the basis of information indicating a setting state included in the acquired control signal. For example, since the user-side control terminal 30 may execute setting change from the user-side control terminal 30, the setting monitoring unit 143 detects the setting change. For example, the setting monitoring unit 143 may detect intrusion of a computer virus. For example, the setting monitoring unit 143 may detect software update (step S307). Here, assume that the setting of the related setting is not a preset setting. The setting monitoring unit 143 transmits a control signal including an instruction to rewrite the value of the related setting and the value of the related setting with which rewriting is to be performed to the transceiver accommodating device 10b (step S308).

The control signal transmitted from the control device 20b is received by the control signal transmission/reception unit 11 via the control signal path SR constructed between the transceiver accommodating device 10b and the control device 20b. The control signal transmission/reception unit 11 converts the received control signal into an electric signal and outputs the electric signal to the switch 13. The control signal output to the switch 13 is input to the main signal transmission/reception unit 12 via the control signal path SR. The main signal transmission/reception unit 12 acquires the control signal transmitted from the control device 20b. The main signal transmission/reception unit 12 rewrites the related setting to be rewritten with the value of the related setting with which rewriting is to be performed on the basis of the rewriting instruction included in the acquired control signal (step S309). Thereafter, the reception control unit 141 notifies the control device 20b of or responds to the control device 20b with a control signal indicating a setting state (setting execution completion or setting value) via the control signal transmission/reception unit 11. Note that in a case where the related setting is monitored at a predetermined interval, the setting monitoring unit 143 monitors the related setting by transmitting a notification instruction to the transceiver accommodating device 10b at a predetermined interval.

According to the communication system 1b in the third embodiment formed as described above, effects similar to those of the first embodiment can be obtained.

Furthermore, in the communication system 1b, the setting monitoring unit 143 is included not in the transceiver accommodating device 10b but in the control device 20b. The control device 20b has higher security than the transceiver accommodating device 10b and is less likely to be attacked.

### Modification 1

The transceiver accommodating device 10b may include the verification unit 144 as illustrated in Modification 2 of the first embodiment.

### Modification 2

The control device 20b may include the verification unit 144.

### Fourth Embodiment

In the fourth embodiment, as an example, a configuration will be described in which, in an instruction from a setting monitoring unit included in a control device, conduction with a control device in a communication network is blocked if a related setting of a main signal transmission/reception unit cannot be appropriately rewritten. A system configuration in the fourth embodiment is similar to that in FIG. 5. Differences from the third embodiment will be mainly described.

A control device 20b in the fourth embodiment includes a setting monitoring unit 143.

If the setting monitoring unit 143 including a block function is on the communication network side (for example, in the control device 20b on the communication network side), handling on the communication network side if an abnormality is detected by the setting monitoring unit 143 or if a detected abnormality cannot be corrected, such as, for example, correction of the abnormality by a reception control unit 141 or blocking in a case where the blocking is on the communication network side is more quickly performed.

The setting monitoring unit 143 in the fourth embodiment generates a control signal including a rewrite instruction and transmits the generated control signal to a transceiver accommodating device 10b, thereby rewriting a related setting of a main signal transmission/reception unit 12. However, the related setting cannot be rewritten with preset information due to some trouble in some cases. In such a case, the setting monitoring unit 143 cannot cause rewriting of the related setting. Therefore, if the related setting cannot be rewritten, the setting monitoring unit 143 included in the control device 20b in the fourth embodiment blocks transmission between the transceiver accommodating device 10b and the control device 20b.

Note that the setting monitoring unit 143 of the control device 20b may detect success or failure on the basis of a result of communication for checking a state for the transceiver accommodating device 10b, a communication state (for example, whether it is a wavelength, intensity, or the like as set, or whether to follow a change instruction such as drift correction or the like) detected on the control device 20b side, or the like. If a notification indicating that the rewriting is successful is obtained, the setting monitoring unit 143 does nothing in particular. On the other hand, if a notification indicating that the rewriting is not successful is obtained, the setting monitoring unit 143 blocks transmission between the transceiver accommodating device 10b and the control device 20b. Further, the setting monitoring unit 143 may perform blocking in a case where there is no notification or response of setting or rewriting, or may perform blocking if there is a failure or abnormality of setting or rewriting.

Here, examples of the method of blocking conduction in the control device 20b in the fourth embodiment include the following methods: blocking conduction by the control device 20b, reducing optical output of the main signal transmission/reception unit 12 to a negligible level (writing of a register or the like) for the transceiver accommodating device 10b, turning off optical transmission (input to a hard pin or writing of a corresponding register or the like), stopping the main signal transmission/reception unit 12, reactivating the main signal transmission/reception unit 12, disconnecting the power supply of the main signal transmission/reception unit 12, blocking conduction of a main signal in the main signal transmission/reception unit 12 between the user device 40 and the control device 20b, turning off feeding of the main signal transmission/reception unit 12, turning off the power supply of the transceiver accommodating device 10b, blocking a signal on the communication network side, and the like. Note that the transceiver accommodating device 10b may also include a configuration for blocking conduction.

If any one of a case where setting cannot be performed, a case where a setting value cannot be set as set, a case where a held setting value is changed by control other than control of the control device 20b, and a case where blocking is performed is satisfied, the reception control unit 141 notifies the control device 20b of or responds to the control device 20b with the fact.

### Modification Common to First Embodiment to Fourth Embodiment

The transceiver accommodating device 10, 10a, 10b may include a monitoring unit that monitors reading of a setting related to the signal transmission/reception unit as a function of the control unit 14, 14a, 14b. If reading of the setting related to the main signal transmission/reception unit 12 is detected by monitoring, the monitoring unit notifies the setting monitoring unit 143 of the fact. If the setting monitoring unit 143 is notified of detection of reading from the monitoring unit, conduction between the main signal transmission/reception unit 12 and the control device 20, 20b in the communication network is blocked.

### Fifth Embodiment

In the fifth embodiment, an example using the Kubernetes, which is a container orchestration tool, is generally described, and a configuration using a specific goldstone will be described thereafter.

A container isolates an execution process by a function of a Kernel by implementing a name space namespace that executes the execution process only in a separated space by grouping the execution process and a control group cgroups that restricts hardware resources for the execution process, and shares a container image in a file system or the like by a copy-on-write (COW) mechanism including a read-only read only layer container image and a thin R/W layer file of a layer that can be written by the execution process. In container deletion, only a layer that can be written is deleted, and thus, in order to save content after activation, the container image is imaged again as a container image together with a new layer, or a mechanism of performing separate writing to an external file is formed.

The container image is a tape archive (TAR) file including a root file system, and is a combination of a file system that operates an application and metadata of JavaScript object notation (JSON) in which a setting such as an activation command and a port are described. A container execution engine is a library that implements a function of a Kernel as an application programming interface (API), calls a container runtime that generates and executes a container as internal operation, and implements container execution. In a case where the container is executed, the container image is developed (filesystem bundled) and delivered to the container runtime. The runtime includes a low-level container runtime such as runC that creates an isolated environment of a container and directly operates the container, and a high-level container runtime such as containerd that develops a container image and delivers a container execution operation to the low-level container runtime.

The Kubernetes calls the high-level container runtime according to the API standard of a container runtime interface (CRI). The Kubernetes is a container orchestration tool that manages containerized workloads and services by performing placement of a container that is an execution form of an application, scheduling for placing appropriate resources by declaring a proper state, self-healing, and infrastructure abstraction according to business workloads. The Kubernetes is described as k8s and its lightweight version is also described as k3s. Two elements included in a Kubernetes cluster are: an object that is an abstract configuration management file that defines a resource such as a container, a network, and a storage that operate on the Kubernetes cluster, deployment content of the container, and a proper state of a policy such as reactivating, upgrade, and connection; and a control plane that is a cluster base that is implementation and a process for implementing the request. An object defined in a YAML Ain't Markup Language (YAML) format is said to be a manifest.

There are four basic objects related to the control plane: Pod, Service, ReplicaSet, and Deployment. The Pod is an object that manages a unit of deploying a container on a cluster, and is a unit of collecting containers that share a Volume or a network group. The Pod is an object that manages a unit of deploying a container on a cluster, and can activate a plurality of containers therein. The Service is an object that sets access routing for a Pod. The ReplicaSet is an object that manages the number of Pods (number of replicas) required in a cluster using a template PodTemplate for creating a Pod. The Deployment is an object that manages release of a new version. Note that the Kubernetes does not handle resources in units of containers.

In the control plane, there are two groups of a Master Node and a Worker Node. The Master Node receives a request from the manifest and schedules a task for an operating container or infrastructure resource. The Worker Node activates or deletes a container in accordance with an instruction from the Master Node, monitors the state of a container activated on its own server, and notifies the Maser Node of the state. The Master Node includes an etcd that is a distributed storage, a kube-apiserver (Kubernetes API) that is an interface that delivers a manifest that defines a state as a resource request, a kube-sheduler that receives processing from them, a kube-controller-manager, and the like. The proper state refers to a state of a resource saved in the etcd.

The Kubernetes API includes a filter that allows only a user account or a service (service account) holding specific authority to refer to or change object information saved in the etcd. A filtering process performs authentication of a connected account, determines authorization of which resources are granted what authority, and determines user-specific resource restriction. The connection source of authentication is roughly divided into a user account of an authentication account targeting connection of an operator or a process from the outside of the cluster and a service account of an authentication account targeting a process executed in a Pod in a namespace of the cluster. The user account is defined in global of a cluster and thus is unique in the cluster regardless of a namespace, and a service account is managed for each namespace and is unique for each namespace. A service account token is mounted on a Pod as a Secret. In the Kubernetes cluster, authentication of a container registry can be performed by creating a Secret of a registered account. However, the Secret is not normally a safe object because the Secret is not encrypted, and thus a measure together with use of RBAC or the like is required.

An authorization module according to an order of an authorization-mode option controls an operation permitted according to the connection source among accesses for which authentication is permitted. If all designated modules perform rejection, a forbidden response (403) is returned, and if any of authorization modules performs approval, the procedure proceeds to evaluation of an admission controller. An evaluation module includes a role-based access (RBAC) of role based access control that defines a RoleBinding that associates an object said to be a Role that defines use authority with a user account or a group and restricts access. In the RBAC, an object obtained by combining a resource and verbs among a subject to be authenticated of a user account or a process, a resource including a Pod, Deployments, Services, and a Node that are API resource sets available in a cluster, and a series of create/read/update/delete (CRUD) operations including get, watch, create, delete, and the like that can be executed on resources is a Role, and the Role and subject are associated with each other by the RoleBinding. For example, a ClusterRole and a ClusterRoleBinding may be used in a case of entire cluster restriction, and may be defined by a combination of the Role and the RoleBinding in a case of restriction in units of namespaces.

An admission control checks request content to the API and changes or controls the request. The admission control is a generic term for an admission controller that is a plug-in type implementation component that performs each filtering operation. Among these components, an AlwaysPullImages that performs authentication of image use at the time of activation of a Pod by enforcing an image acquisition policy may enforce the Pod to be a Pod including a functional unit (for example, any one of a reception control unit 141, a setting monitoring unit 143, 143a, and a verification unit 144) used in the present application, or a Token of a predetermined policy may be mounted by a ServiceAccount that mounts a ServiceAccoutToken for accessing the Kubernetes API. A MutatingAdmission Webhook or a ValidatingAdmission Webhook may be used for flexible restriction.

### <Prevention of Modification>

Therefore, in a case where a user account is used in the present embodiment, a user having lower authority than a user controlled by a control device 20 on a communication network side is set, and a Namespace of a Pod in which a functional unit (for example, any one of the reception control unit 141, the setting monitoring unit 143, 143a, and the verification unit 144) of the present application is disposed and a Namespace of the other Pod are separated for the user, or a Namespace of a Pod capable of controlling a setting that should not be controlled by the user and a Namespace of the other Pod are separated so that control cannot be performed from the user account.

In a case where the service account is used and the access from the user can be restricted to only a teletypewriter (tty) input or only a COM input corresponding to a serial connection, restriction is performed in units of namespaces, and thus, defining may be performed by the Role or a combination of the Role and a RoleBinding. In the present embodiment, the monitoring function itself may not be restricted as long as the monitoring function is not disposed on a transceiver accommodating device 10. For example, it may be targeted as a Subject for a customer (login ID), TTY or the like (via CUI), or a management port (IP address). In order to prevent network connection, information of an operation of a Service may not be exchanged using a Resource, or forbidding accessing a Pod in which control related to a setting not to be controlled is collected may be performed. Note that a Secret of a namespace related to a setting for restricting access to a functional unit of the present application or a user is not to be seen, but deletion change of a functional unit or access to the setting for which access is to be restricted may be prevented by authorization or an Access Control.

However, if a Secret can see change or the like, access can be made by falsifying the ID, and thus, in a case where connection with the control device 20 of the communication network is checked and connection is disconnected by releasing connection with the communication network of a control signal transmission/reception unit 11, or in a case where a setting value or the like is checked from the control device 20 of the communication network and connection other than connection from the communication network or change is detected, it is desirable to disconnect a main signal, and perform conduction again after inspecting the setting, the authentication information, and the like and confirming that the setting, the authentication information, and the like are normal.

From the viewpoint of preventing a setting or the like that should not to be accessed by a user from being changed by releasing connection with the communication network of the control signal transmission/reception unit 11, also in the previous embodiments (the first to fourth embodiments), in a case where connection with the control device 20 of the communication network is checked and connection is disconnected by releasing connection with the communication network of the control signal transmission/reception unit 11, or in a case where a setting value or the like is checked from the control device 20 of the communication network and connection other than connection from the communication network or change is detected, it is similarly desirable to disconnect a main signal, and perform conduction again after inspecting the setting, the authentication information, and the like and confirming that the setting, the authentication information, and the like are normal.

### <Prevention of Deletion of Functional Unit of Present Application>

A Pod including a functional unit (for example, any one of the reception control unit 141, the setting monitoring unit 143, 143a, and the verification unit 144) of the present application desirably has high priority so that the functional unit of the present application is not stopped. Specifically, in a case where a NodeName, which is a field of a node to be executed in the definition of a Pod, is not designated and a Worker Node is not designated at the time of new creation or re-creation of the Pod, a suitable Worker Node is selected by a kube-scheduler that always monitors an undesignated Pod, the NodeName is updated, a kubelet operating in a target Worker Node is notified of a request for adding a new Pod, and the worker Node Pod is activated. On the other hand, in a case where a Pod does not fit on a specific node, a Pod determined to be inappropriate by a Predicate that is filtering for removing an inappropriate Node is removed. Therefore, weighting is desirably performed such that Priority of a priority order of nodes is obtained in which a Pod including a functional unit of the present application is notified of a request for adding a new Pod in a case where there are no sufficient Pods in which the functional unit operates, and is not deleted in a case where there are Pods insufficient for the functional unit to operate if the Pod is deleted.

Similarly, in a case where an autoscale of a Pod is set, setting is performed such that deletion is not performed by an increase or decrease in the number of Pods in scale-out/in in a horizontal Pod autoscaler (HPA). In a case of an increase, security is prevented from deteriorating. Processing capability (communication speed and frequency with a function on the network side, or speed and frequency of monitoring and blocking) necessary for the present application is secured by an increase or decrease of processing capability of a Pod itself in scaling up or scaling down in a Vertical Pod Autoscaler (VPA). Note that, in a VPA that does not permit dynamic resource change for an operating Pod, deletes a Pod by an operation or the like via an Eviction API, and a Pod of an appropriate resource is obtained by re-creating a Pod by a self-healing function of a ReplicaSet or the like, deletion is not performed in a case where the number of Pods becomes less than one regarding a Pod related to processing of the present application. Alternatively, it is desirable that the time during which the processing of the present application in a series of flows is hindered is made to be a predetermined time or less, or the processing is prevented if the time is not the predetermined time or less. In a case where a Pod Disruption Budgets is set, it is desirable that, regarding the Pod related to the processing of the present application, the value is made to be sufficiently smaller than a duration of an abnormal state allowed in a service.

### <Setting Not to Be Accessed, TLS Type Used as Certificate With Control Device 20 on Communication Network Side, and Securement of Confidentiality of Authentication Information of Docker Image>

A Secret or a ConfigMap object such as a value in an encrypted Key-Value format different for each user account may be registered at the time of activation by a manifest or the like, and caused to be read as an environmental variable of a Pod so as to be read on the Pod or caused to be read by a volume being mounted. Here, the Secret or the ConfigMap is a volume for managing an environmental variable or a setting file of the application as an object different from a Pod without including the environmental variable or the setting file of the application in a container. The Secret is an object that handles credential information, is appropriately encrypted and saved in an etcd, is deployed in a tmpfs, which is a temporary file system secured in a memory area on a worker node at the time of use, and does not leave persistent data in the worker node. The ConfigMap manages a plain text content as a volume.

In a case where these are used, a Deployment may be updated and a Pod may be switched in order to perform reflection in a Pod that has already activated, or a reread setting on the process side or reactivation may be performed in order to perform reflection in a process of the container. As a field for performing reflection in a Pod as an environmental variable, “valueFrom.configMapkeyRef”, “envFrom[ ].configMapRef”, or the like may be used. Instead of a Pod manifest, a PodPreset, which is a hook function for adding specific information at the time of Pod creation on the basis of a label selector, may be used to dynamically designate a specific environmental variable at the timing of Pod activation. In a case where the PodPreset is used, common information can be used without all information being designated for each Pod every time, and necessary information and confidential information can be dynamically assigned regardless of the deployment environment.

### <Method of Checking Whether it is Application Used in Present Application>

Various business requests for an application or a service are defined, and cataloging based on a service catalog defined by information technology infrastructure library (ITIL) or the like, which is a template set of functions, may be utilized, in which not only configuration information but also a design capable of guaranteeing a deployment process, operation thereof, or quality thereof can be considered. Here, the service catalog is an extended API for using software or a service outside the cluster that is used by an application executed on the Kubernetes cluster for connecting a non-containerized resource such as a managed database or an object storage provided by a cloud provider or the like, and does not mean a Service Catalog of the Kubernetes using the open service broker API standard.

As a request definition of the application, an example has been described in which an object such as a Deployment, a Service, and a ConfigMap is individually associated by a label and a selector, but in order to package a manifest according to a workload to facilitate management, elements necessary for a specific application or service may be determined in advance, an object that can correspond to the elements may be packaged into a template, and package management for rolling back or version management of the application may be performed by applying this package. For example, a Helm, which is a package management tool in the Kubernetes that can reduce the work of management of a Deployment or a Service for each workload of the application, and handling and processing of variables and volumes using a ConfigMap, may be used. The Helm is a package obtained by templating and putting together a manifest of the Kubernetes, and is a client tool that manages a Chart, which is a set of YAMLs. In a case of a Helm version 2, the entire package management function includes components of a Helm (Client), which is a client tool that calls a Chart from the console or the pipeline of CI/CD, and a Tiller (Server), which is a service that operates on the Kubernetes cluster and deploys and manages the Chart, and the Helm client interacts with the Tiller via a gRPC to transmit information of the Chart to be deployed and instruct a request for upgrade or uninstallation. The Tiller directs the Kubernetes to configure the Chart requested by the Helm client and manages deployment of resources. In a case of a Helm version 3, instead of utilizing a Tiller that compares a version expanded on the Kubernetes with a release version of a Chart and manages a resource, the release information is stored in a custom resource definition (CRD) and operated from the client side. Using this mechanism, whether the application (for example, any one of the reception control unit 141, the setting monitoring unit 143, 143a, and the verification unit 144) used in the present application is an appropriate version may be simply checked. For example, a Release.Time, which is a defined variable of a Chart and is a time when the release is most recently updated, a Release.Revision, which is a revision number that increases from one every time update is performed, a version field of a Chart.yaml, or the like may be used. If an inappropriate version is detected, a Pod having a difference or all Pods may be restored to an appropriate version by rolling back, and if the version cannot be restored, blocking may be performed.

Of course, using a Control Loop, which is a mechanism that implements a core resource such as a Pod and a Deployment managed by the Kubernetes by a resource possessed by the Kubernetes and a controller and including three states of “Observe” in which a Current State, which is a current operating state, is monitored, “Diff” in which a difference between the Current State and a Desired State is compared, and “Act” in which a state is adjusted to an appropriate state, monitoring, detection, and adjustment may be performed, adjustment to an appropriate state may be performed, and if adjustment cannot be performed, blocking may be performed. Here, if the Control loop is a Deployment, management is performed by a Deployment controller. Operational implementation of an application (for example, any one of the reception control unit 141, the setting monitoring unit 143, 143a, and the verification unit 144) that is a custom resource added as a unique resource in the present application may be monitored, detected, and adjusted from the Kubernetes utilizing “custom resource” and “custom controller”.

Here, the custom resource is a unique data structure obtained by extending an existing Kubernetes API, and a box of extended resources for managing a Desired State and a Current State of an object saved in an etcd is created, state information unique to the application and a flag necessary for a cluster management of middleware are stored, and a state managed only on the application side so far is saved as a resource of the Kubernetes, thereby the state of the object is adjusted by the controller using the Control Loop. Also in this case, if the adjustment cannot be appropriately performed, blocking may be performed.

Note that, as the custom resource, API extension may newly implement an object as an Aggregated API in the Kubernetes API using an API Aggregation and API-registering the object in an Aggregation Layer, thereby performing detail defining and extending, or may newly define a resource without creating a unique API by customer resource definition (CRD), thereby performing extending, but the latter API extension by the CRD is used in an Operator. The custom controller checks the state of a custom resource or a core resource (Diff), and adjusts an object managed in a case where there is an Event to be updated in the Desired State of the resource (Act).

Next, a configuration using a Goldstone as software incorporated in the transceiver accommodating device 10 will be described. In the above-described embodiments, the transceiver accommodating device 10 not including a block function (for example, first embodiment and third embodiment) and the transceiver accommodating device 10 including a block function (for example, second embodiment and fourth embodiment) have been described. Also in the description of the fifth embodiment, a case of including a block function and a case of not including a block function will be described separately.

### Case of Not Including Block Function

As a configuration in a case of not including a block function, the transceiver accommodating device 10 according to the first embodiment will be described as an example. Note that basic processing is similar also in the transceiver accommodating device 10b according to the third embodiment. As software that operates on the control unit 14 of the transceiver accommodating device 10 according to the first embodiment, a set of a network OS of a white box switch, a Goldstone, a monitoring setting function, and the like is installed in the white box switch. The reception control unit 141 and the setting monitoring unit 143 that are monitoring setting functions may be applications on an OS different from the Goldstone or applications on the Goldstone.

In a case where the reception control unit 141 and the setting monitoring unit 143 are applications on the Goldstone, the reception control unit 141 and the setting monitoring unit 143 are applications that are not included in a normal Goldstone, and the applications may be applications on containers on different Pods, may be applications on different containers on the same Pod, may be applications on the same container on the same Pod, or may be integrated applications. They may be applications obtained by modifying some applications of an existing Goldstone.

For example, as a configuration in which change in the transceiver accommodating device 10 is small, the reception control unit 141 is a North Management Interface including a command line interface (CLI), a netfonf, a simple network management protocol (SNMP), a restconf, and the like in advance, or a Sysrepo in which they write values. The setting monitoring unit 143 is a TAI or a tai shell. Note that the configuration illustrated in FIG. 9 of Non Patent Literature 1 corresponds to a South TAI of a South Management Layer. The North Management Interface, the Sysrepo, or the South TAI may be modified so as to include a function of receiving only a value via a predetermined path from the communication network and rewriting a related setting with the value, or the function may be separately included in parallel with the North Management Interface or the South TAI.

In a case where the verification unit 144 is included as a function implemented on the control unit 14 in the transceiver accommodating device 10 according to the first embodiment, the verification unit 144 can desirably check whether setting to an appropriate register is performed. For example, in a case where a setting of a Sysrepo or the like is accessed, containers of a plurality of settings of the Sysrepo or the like are started, and if setting to a setting not related to the register of the main signal transmission/reception unit 12 is performed, the object of the present invention cannot be achieved. Therefore, the verification unit 144 verifies whether setting to an authentic setting related to the main signal transmission/reception unit 12 is performed.
An application that uses a Sysrepo (the Sysrepo is a YANG-based data store for a UNIX (registered trademark)/Linux (registered trademark) system, and stores application configurations described in the YANG format) may be restricted by a NETCONF (the Sysrepo can manage an application that uses a Sysrepo integrated with a Netopeer2 NETCONF server by the NETCONF)
Since the Sysrepo does not include a master process that can enforce complex access control, it relies on standard file system permission and is used with the following in mind. Always set the correct authority and owner for all YANG modules to be installed in order to ensure that confidential data is not accessible from unauthorized processes. In addition to this function that can be used in the API, use a utility Sysrepoctl for both display (--list) and change (--change<module>) of all authorities. Completely suspend a Sysrepo by performing writing to shared files that need to be accessible from all processes linked to the Sysrepo. Depending on reverse engineering, adjust two cmake variables of a Sysrepo_umask and a Sysrepogroup so that data is not accessed by a denormalization process when data is being communicated in these shared files. Generally, create a new system group and set the new system group in the Sysrepo_group, and then set a Sysrepojmask to 00007 so that all external accesses are forbidden. If all user accounts executing a Sysrepo process belong to this group, make the Sysrepo files and confidential information not accessible from other user accounts.

### Case of Including Block Function

As a configuration in a case of including a block function, the transceiver accommodating device 10 according to the second embodiment will be described as an example. Note that basic processing is similar also in the transceiver accommodating device 10b according to the fourth embodiment. As software that operates on the control unit 14 of the transceiver accommodating device 10 according to the second embodiment, a set of a network OS of a white box switch, a Goldstone, a monitoring setting function, a block function, and the like is installed in the white box switch. The reception control unit 141 and the setting monitoring unit 143 that are monitoring setting functions, and the setting monitoring unit 143 that is a block function may be applications on an OS different from the Goldstone or applications on the Goldstone.

In a case where the reception control unit 141 and the setting monitoring unit 143 are applications on the Goldstone, the reception control unit 141 and the setting monitoring unit 143 are applications that are not included in a normal Goldstone, and the application may be applications on containers on different Pods, may be applications on different containers on the same Pod, may be applications on the same container on the same Pod, or may be integrated applications. They may be applications obtained by modifying some applications of an existing Goldstone.

For example, as a configuration in which change in the transceiver accommodating device 10 is small, the reception control unit 141 is a North Management Interface including a CLI, a netfonf, an SNMP, a restconf, and the like in advance, or a Sysrepo in which they write values. The setting monitoring unit 143 is a TAI or a tai shell. Note that the configuration illustrated in FIG. 9 of Non Patent Literature 1 corresponds to a South TAI of a South Management Layer. The North Management Interface, the Sysrepo, or the South TAI may be modified so as to include a function of receiving only a value via a predetermined path from the communication network and rewriting a related setting with the value, or the function may be separately included in parallel with the North Management Interface or the South TAI.

A Dying GASP equivalent is desirably transmitted to the control device 20 side, but estimation may be performed on the control device 20 side by checking block of a Keep alive or Health check equivalent.
An application that uses a Sysrepo (the Sysrepo is a YANG-based data store for a UNIX (registered trademark)/Linux (registered trademark) system, and stores application configurations described in the YANG format) may be restricted by a NETCONF (the Sysrepo can manage an application that uses a Sysrepo integrated with a Netopeer2 NETCONF server by the NETCONF)
Since the Sysrepo does not include a master process that can enforce complex access control, it relies on standard file system permission and is used with the following in mind. Always set the correct authority and owner for all YANG modules to be installed in order to ensure that confidential data is not accessible from unauthorized processes. In addition to this function that can be used in the API, use a utility Sysrepoctl for both display (--list) and change (--change<module>) of all authorities. Completely suspend a Sysrepo by performing writing to shared files that need to be accessible from all processes linked to the Sysrepo. Depending on reverse engineering, adjust two cmake variables of a Sysrepo_umask and a Sysrepogroup so that data is not accessed by a denormalization process when data is being communicated in these shared files. Generally, create a new system group and set the new system group in the Sysrepo_group, and then set a Sysrepojmask to 00007 so that all external accesses are forbidden. If all user accounts executing a Sysrepo process belong to this group, make the Sysrepo files and confidential information not accessible from other user accounts.

### Modification 1

The transceiver accommodating device 10, 10a, 10b according to the fifth embodiment may restrict addition or duplication of a new Namespace, Node, or container that is related to deletion modification of a functional unit (for example, the reception control unit 141, the setting monitoring unit 143, and the verification unit 144) added in the embodiments and bypassing processing of the functional unit added in the embodiments by a Kubanetes or the like. In this case, it is sufficient that a state in which a container in which the setting monitoring unit 143 on the transceiver accommodating device 10, 10a, 10b is disposed, a Node corresponding to the container, or the like cannot be accessed from the control device 20, 20b, or a state in which rewriting cannot be performed in a case where the setting monitoring unit 143 rewrites a setting value is avoided.

### Modification 2

The transceiver accommodating device 10, 10a, 10b according to the fifth embodiment may be activated as follows. Even if the user-side control terminal 30 logs in to the transceiver accommodating device at the time of reauthentication and reactivation from the time of activation, such as block at the time of activation or stop or connection to a control device (APNC) of the all-photonics network, the transceiver accommodating device may not be reactivated, and the transceiver accommodating device may be activated only in a form in which the transceiver accommodating device accepts only control from the control device (gateway) side (block at activation or stop, connection to a control device of an all-photonics network, reauthentication from activation).

### Modification 3

The transceiver accommodating device 10, 10a, 10b according to the fifth embodiment may automatically start up as follows. In the automatic startup, for example, in a normal startup sequence, if the Goldstone activation screen→in Kubanetes immediately after activation→tai shell stop (tia.sh stop)→tai shell activation (tia.sh start)→south-tai reactivation (k rollout restart ds/south-tai)→tai shell activation (k exec-it deploy/tai--taish)→each PIU (plug-in unit) is entered from the tai shell (module/dev/piu1, here, an example of piu1)→the main signal transmission/reception unit 12 is activated (set admin-status up) is set, automatic startup is also performed on that.

### Modification 4

In the transceiver accommodating device 10, 10a, 10b according to the fifth embodiment, an ID of authority lower than administrator authority may be created, and only the ID of the lower authority may be made accessible to a user. Furthermore, a file of software or a setting related to deletion modification of functional units added in the embodiments is set to be unreadable, unwritable, unexecutable, or only readable by the ID of the lower authority. In a case of a file, the mode is ---(0) or r--(4) (read/write/execute).

### Modification 5

The transceiver accommodating device 10, 10a, 10b according to the fifth embodiment may perform the following access restriction related to deletion modification of the functional units added in the embodiments.
The IP address may not be searched.

Address resolution and advertisement of an IP address of a functional unit itself, a setting value, a container in which the functional unit and the setting value are disposed, or the like are prevented in a routing table of a Kubanetes or the OS, and the IP address is set to a value that is difficult to be estimated, thereby preventing access.
For access to an API Server (Kubernetes control plane), an IP address required for cluster management may be restricted, or access to a related Node may be restricted by a network access control list.
Using an mTLS or the like, network traffic between services related to a TAI is encrypted.
A security policy that enforces the authority of a Pod or a container in the Kubernetes or an OPA Gatekeeper may be used.
Although there is no access restriction by default in the Kubernetes, an ingress rule may be described for a Pod by using a Network Policy, and access control may be performed in units of Pods (in units of IP addresses) or in units of TCP/UDP ports by the ingress rule.

### Hardware Configuration Example

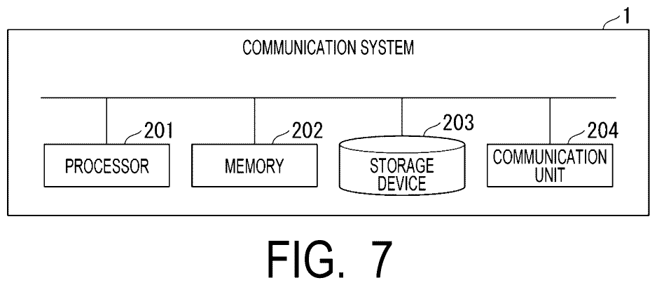

FIG. 7 is a diagram illustrating an example hardware configuration of the communication system 1a, 1b in the embodiments. Some or all of the functional units (for example, the reception control unit 141, the setting monitoring unit 143, and the verification unit 144) of the communication system 1a, 1b are implemented as software by causing one or more processors 201 such as central processing units (CPUs) to execute a program stored in a storage device 203 including a non-volatile recording medium (non-transitory recording medium) and a memory 202. The program may be recorded in a computer-readable non-transitory recording medium. The computer-readable non-transitory recording medium is, for example, a portable medium such as a flexible disk, a magneto-optical disc, a read only memory (ROM), or a compact disc read only memory (CD-ROM), or a non-transitory recording medium such as a storage device such as a hard disk built in a computer system. A communication unit 204 performs predetermined communication processing. The communication unit 204 may acquire data (for example, main signal data, wavelength data) of an optical signal transmitted through an optical fiber and a program.

Some or all of the functional units of the communication system 1a, 1b may be implemented by using, for example, hardware including an electronic circuit (electronic circuit or circuitry) using a large scale integrated circuit (LSI), an ASIC, a PLD, an FPGA, or the like.

Although the embodiments of the present invention have been described in detail with reference to the drawings, specific configurations are not limited to the embodiments, and include design and the like within the scope of the present invention without departing from the gist of the present invention.

### INDUSTRIAL APPLICABILITY

The present invention can be applied to an optical communication system such as an all-photonics network (APN).

### REFERENCE SIGNS LIST

1, 1a, 1b Communication system
10, 10a, 10b Transceiver accommodating device
20 Control device
30 User-side control terminal
40 User device
11 Control signal transmission/reception unit
12, 15 Main signal transmission/reception unit
13 Switch
14, 14a, 14b Control unit
141 Reception control unit
143, 143aSetting monitoring unit
144 Verification unit

1. A communication system comprising:
a main signal transceiver configured to transmit and receive a main signal to and from an opposing device via a communication network in which a control device is disposed; and
a setting monitor configured to monitor a related setting in which change of a setting related to the main signal transceiver is to be restricted, and performs rewriting with preset information or blocks transmission between the main signal transceiver and the control device disposed in the communication network in a case where a setting of the related setting is not a preset setting.

2. The communication system according to claim 1 further comprising:
a control signal transceiver configured to transmit and receive a control signal to and from the control device disposed in the communication network; and
a reception controller configured to construct a control signal path that enables access to the related setting with the control device via the control signal transceiver.

3. The communication system according to claim 2,
wherein the setting monitor and the reception controller are included in an accommodating device installed in a user's home including the main signal transceiver and the control signal transceiver.

4. The communication system according to claim 2,
wherein the reception controller is included in an accommodating device installed in a user's home including the main signal transceiver and the control signal transceiver,
the setting monitor is included in the control device, and
the setting monitor monitors the related setting at a predetermined interval or in response to a response from the reception controller and rewrites the related setting with preset information, or blocks transmission between the main signal transceiver and the control device disposed in the communication network in a case where a setting of the related setting is not a preset setting.

5. The communication system according to claim 1, further comprising a verifier configured to verify whether a setting for the related setting is valid,
wherein the setting monitor blocks transmission between the main signal transceiver and the communication network in a case where the verifier determines that a setting is not valid.

6. A setting monitoring method comprising:
transmitting and receiving a main signal to and from an opposing device via a communication network in which a control device is disposed; and
monitoring a related setting in which change of a setting related to a main signal transceiver that transmits and receives the main signal is to be restricted, and performing rewriting with preset information or blocking transmission between the main signal transceiver and the control device disposed in the communication network in a case where a setting of the related setting is not a preset setting.

7. A non-transitory storage medium that stores a program for making a computer perform processes, the processes comprising:
monitoring a related setting in which change of a setting related to a main signal transceiver that transmits and receives a main signal to and from an opposing device via a communication network in which a control device is disposed is to be restricted, and performing rewriting with preset information or blocking transmission between the main signal transceiver and the control device disposed in the communication network in a case where a setting of the related setting is not a preset setting.
